(19) United States
(12) Patent Application Publication
(10) Pub. No.: US 2019/0193566 A1
(43) Pub. Date: Jun. 27, 2019

(54) Automatic charging when driving on a road having contacts

(71) Applicant: Sten R. Gerfast, Mendota Heights, MN (US)

(72) Inventor: Sten R. Gerfast, Mendota Heights, MN (US)

(21) Appl. No.: 15/732,768

(22) Filed: Dec. 26, 2017

(51) Int. Cl. B60L 5/40; B60M 1/36; B60L 5/00; B60L 11/18; G05D 1/02; E01F 15/08; A01M 29/16; A01M 29/24

(52) U.S. Cl. CPC B60L 5/40; B60M 1/36; B60L 5/005; A01M 29/24; G05D 1/0278; E01F 15/08; A01M 29/16; B60L 11/182

(57) ABSTRACT

This invention is a convenient system to charge an electric vehicle, or a hybrid vehicle, during its travel on a road. What sets this invention apart, is that the electric charging is done during normal driving on a special road. It is a convenient, automatic charge method, wherein the driver does nothing except driving. Many types of electric vehicles can be charged automatically, with the charging fee being done automatically, by a license plate scanner.

### DESCRIPTION OF THE INVENTION

This invention is a convenient, automatic system to charge an electric vehicle, or a hybrid vehicle, during its travel on a road.

What sets this invention apart, is that the electric charging is done during normal driving on a special road, and solves a problem.

This is a convenient, automatic charge method, wherein the driver does nothing except driving. Electric vehicles do need to be charged with electric power sufficient to reach their destination, which is not always the case? This invention provides for a convenient method to accomplish this charging while driving onto a specially prepared road.

This road is having electrical contacts on a fence by the side of the road.

It could be a one-way direction roadway, with a wall on one side, having a non-conducting enclosure containing two stationary electrical contacts which are supplying current, mating with two electrical receiving conductive contacts in the vehicle.

These conductive electrical vehicle contacts are extendable and retractable from the vehicle, to their proper position. The two or more contacts make a good electric connection by a design that has a spring-loaded construction.

The vehicle contacts are supported by a non-conductive enclosure which can be totally invisible when retracted into the vehicle. The continuing enclosure in the wall of the charging road, can have protecting sheets made of non-conductive material, of rectangular, round or oval shape.

The electrical strips inside the non-conductive enclosures, are constructed of a low resistance, high conductance material for securely transferring the electrical current into the vehicle.

The enclosures are mounted on a supporting fence.

The fence is preferably made from corrugated or indented material to increase its stiffness and strength, but still be cost-effective.

The enclosures are mounted interlocked with the fence, which could have a support wires, to resist high wind or snow.

The fence, and its other components, can be mounted either on the on the left side or the right side of the road, depending on the customs of the country where it is installed.

To deter animal and birds to stay around the charging road, a high frequency annoyance signal can be used.

For test purposes of this inventions feasibility, a short section full size fence, with some electrical contacts, have shown surprising results.

The inventor has studied the literature without finding any specific prior art.

Only when a vehicle enters the charging road, the charging current is turned on, to save power during non-use. Sensing for the vehicle can be done optically, magnetically, by LED or by GPS.

The vehicle could enter the prepared charging road at low speed, or it could enter at a designated speed for that section, with earlier entering, and later entering vehicles, both having a uniform speed.

If this invention would be used for “self-driving” vehicles, it would allow the driver of the vehicle having a rest during the charging period on this “charging road”. This could be very important for drivers of truck vehicles. Another self-driving application is for delivery vehicles of packages, luggage or materials.

The cost for the electric charge, could be automatic by a license-plate scanner. After the vehicle enters the charging road, the conductive electrical vehicle contacts are extended to contact the semi-tubular electrical strips.

These conductive electrical strips can either have AC (alternating current or DC (direct current).

Additionally, an alternate charge method can be used, by having mating primary and secondary inductors that inductively transferring AC power from the strips to a secondary inductor in the vehicle.

This type of inductive transformer coupling between closely spaced inductors can be accomplished during the vehicle motion on the charging road. This inductive transfer can also be done with a high frequency for better efficiency.

### BRIEF DESCRIPTION OF THE DRAWINGS

FIG. 1 is showing the vehicle traveling on a charging road with the the receiving contacts in the vehicle extended.

A supporting corrugated fence, is shown in dashed lines, mounted on the road bed either with cement or with fastener.

The vehicle is shown with several attached guidance and safety gear.

FIG. 2 is showing a larger view of the receiving contacts, in center of the charging contacts attached to a fence.

FIG. 3 is showing the top of the vehicle with its many accessories.

### DETAILED DESCRIPTION OF THE DRAWINGS

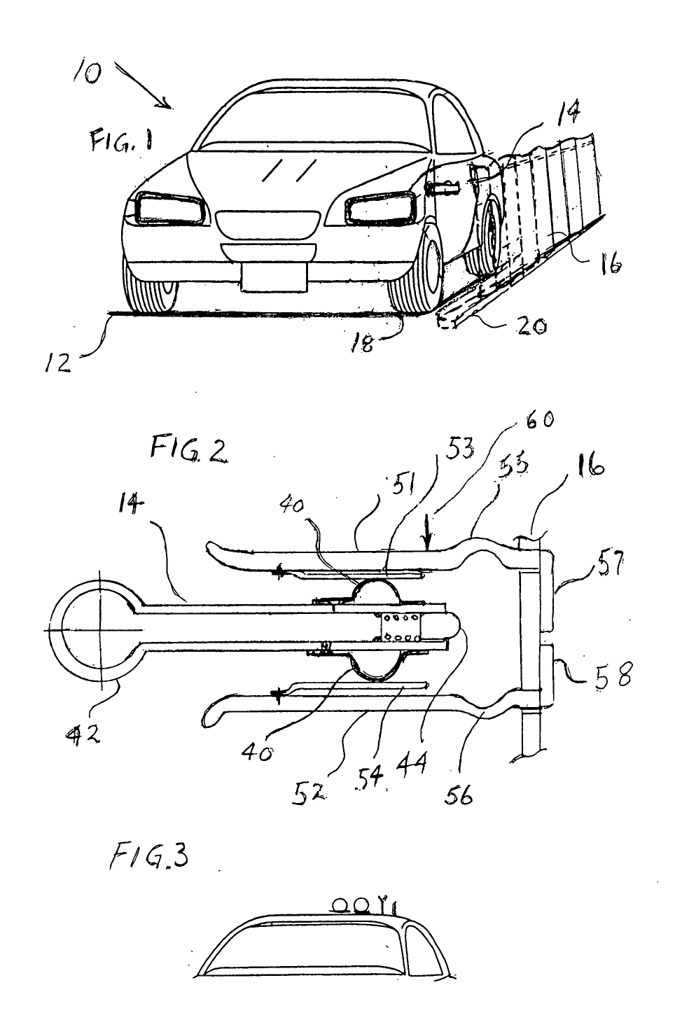

FIG. 1 is showing the vehicle 10 traveling on a charging road 12 with the the receiving contacts 14 in the vehicle extended.

A supporting corrugated fence, 16 is shown in dashed lines, mounted on the road bed 18 either with cement 20 or with fastener.

FIG. 2 is showing a larger view of the receiving contacts, 40 attached to the non-conducting arm 14 having a spherical attachment point 42 that is fit into a hollow non-conducting spherical cavity in the vehicle 10, not shown. This cavity allows the arm 14 to adjust itself both up and down, as well as side-ways, and also be folded into the body of vehicle 10. The contacts 40 have electrical connections to the vehicle, not shown for reason of clarity of the Figure. At the end of the arm 14 is a spring loaded non-conducting plunger 44 to prevent accidental touch. Along the arm 14 is a non-conducting rectangular top 51 and bottom 52 sheet having attached charging contacts 53 and 54 carrying high charging current.

The charging contacts are only attached on one side for conformance and flexibility. The non-conducting sheets 51 and 52 has a curvature 55 and 56, and thereby having weak points for flexibility, before they are securely attached at 57 and 58 to fence 16.

An arrow 60 indicates the possibility of spring loading sheets 51 and 52, as well as opening them for entrance purposes.

FIG. 3 is showing a multitude of accessories on on the vehicle 10. These signify the several attached guidance and safety gear.

The above summary is not intended to describe each described embodiments or every implementation of the present invention.

Figures and the detailed description described herein, is not intended to limit other embodiments

1. Electrical charging of a vehicle during its motion along an electrified fence on the side of a roadway thereby receiving more current, then is used by said vehicles propulsion devises.

2. Electrical charging of a driver-less vehicle during its motion along an electrified fence on the side of a roadway thereby receiving more current, then used by said vehicles propulsion devises, and continuously doing so.

3. Electrical charging according to claim 1 wherein the vehicle is driver-less and equipped with automatic speed control and automatic tracking devises.

4. Electrical charging according to claim 1 wherein the vehicle is having receiving conductive contacts, which can be extended, and additionally, can be retracted into the vehicles body.

5. Electrical charging according to claim 2 wherein during the vehicles motion, a specified distance from the fence is determined and guided by GPS or soft-ware.

6. Electrical charging according to claim 2 wherein the vehicles receiving contacts are touching supply contacts, inside an enclosure, having contacts, which are attached to a fence.

7. Electrical charging according to claim 2 wherein the vehicles receiving contacts, that are touching the supply contacts, are having a spring type design, assuring god electrical contacting between the two parts.

8. Electrical charging according to claim 2 wherein the vehicle is equipped with one or more cameras or infra-red or GPS devises, and equipped with rubber tires.

9. A method according to claim 2, to continuously making contacts between a moving vehicle's receiving contacts, by contacting supply contacts that are stationary along a roadway.

10. A one-way direction roadway, with a wall on one side, with a fence having a high frequency annoyance signal,
and pulsed current for anti-animal deterrent, a non-conducting enclosure containing two stationary electrical contacts,
which are supplying current, mating with two electrical receiving conductive contacts in a continuously moving vehicle.

11. Electrical charging according to claim 10 wherein both the supply current contacts and the receiving type contacts are each spring loaded, and also spring loaded together.

12. Electrical charging according to claim 10 wherein the supply type contacts are securely fastened, and interlocked with a supporting fence.

12. Electrical charging according to claim 10 wherein the described contacts are either carrying AC, alternating current or DC, direct current.

13. Electrical charging according to claim 10 wherein the transfer from supply to receive can be made by can be mating primary and secondary inductors that inductively transferring AC power from the primary on the fence, to a secondary inductor in the vehicle, possibly by high frequency, during the vehicle's motion.

14. Electrical charging according to claim 10 wherein the fence is placed between two countries.
